(19) United States
(12) Patent Application Publication
(10) Pub. No.: US 2024/0319025 A1
(43) Pub. Date: Sep. 26, 2024

(54) CONTACT DETECTING SENSOR, AND CONTACT DETECTING DEVICE

(71) Applicant: KABUSHIKI KAISHA TOKAI-RIKA-DENKI-SEISAKUSHO, Aichi (JP)

(72) Inventors: Takahiro TANAKA, Niwa-gun, Aichi (JP); Seiya MURASE, Niwa-gun, Aichi (JP)

(21) Appl. No.: 18/547,219

(22) PCT Filed: Jan. 26, 2022
(86) PCT No.: PCT/JP2022/002959

§ 371 Date: Aug. 21, 2023

(30) Foreign Application Priority Data
Mar. 3, 2021 (JP) 2021-033843

(51) Int. Cl. G01L 1/14; B62D 1/06; G01L 5/22

(52) U.S. Cl. CPC G01L 1/14; B62D 1/06; G01L 5/221

(57) ABSTRACT

In a sensor assembly (30), a sensor electrode (34) and a sensor electrode (36) are stacked on one another, and the sensor electrode (36) is disposed inward of the sensor electrode (34) in a radial direction of a rim portion (16). Further, an outer side, in a radial direction of a steering wheel (14), of the sensor electrode (36) is covered by the sensor electrode (34), and projecting margin portions (40) that are exposed from the sensor electrode (34) on the radially inner side of the steering wheel (14) are formed in the sensor electrode (36). As a result, in the sensor assembly (30), a structure for a palm to come into contact with the sensor electrode (34) and for a finger of a driver to come into contact with the projecting margin portions (40) of the sensor electrode (36) when the driver grips the steering wheel (14) is simplified.

### TECHNICAL FIELD

The present disclosure relates to a contact detecting sensor and a contact detecting device.

### BACKGROUND ART

In a sensor system of Japanese Patent No. 5871422, a sensor S1, a sensor S2, and a sensor S3 that detect contact of a driver are disposed on a steering wheel rim surface. The sensor S1 and the sensor S2 are disposed on a left front surface and a right front surface of the steering wheel, respectively, and the sensor S3 is disposed behind the sensor 1 and the sensor 2 in the steering wheel.

In the sensor system, it is determined that the steering wheel is not in contact with the driver, is in contact with two hands of the driver, is in contact with only one hand or finger of the driver, or the like from impedance values of the sensor 1, the sensor 2, and the sensor 3.

### SUMMARY OF INVENTION

### Technical Problem

However, a structure in which two electrodes are disposed separately by bringing the two electrodes close to each other in a circumferential direction of the rim of the steering wheel so as not to be in electrical contact with each other is complicated.

The disclosure has been made in view of the above fact, and an object of the disclosure is to provide a contact detecting sensor and a contact detecting device capable of detecting a contact state with a steering wheel with a simple structure.

### Solution to Problem

A contact detecting sensor according to a first aspect of the disclosure for achieving the above object includes: a first electrode unit that is disposed in a rim portion of a steering wheel and detects contact of an operator with a circumferential surface of the rim portion; and a second electrode unit which is disposed on an inner side in a radial direction of the rim portion with respect to the first electrode unit, and in which a detection region used for detecting contact of the operator with the circumferential surface of the rim portion is located at a position different from a position of a detection region of the first electrode unit in a circumferential direction of the rim portion.

In a contact detecting sensor according to a second aspect, in the first aspect, the detection region of the first electrode unit and the detection region of the second electrode unit are continuous in the circumferential direction of the rim portion.

In a contact detecting sensor according to a third aspect, in the first or second aspect, one of the detection region of the first electrode unit and the detection region of the second electrode unit is located on a back side or a rotation center side of the steering wheel.

In a contact detecting sensor according to a fourth aspect, in the third aspect, the other of the detection region of the first electrode unit and the detection region of the second electrode unit is located on a front side of the steering wheel or an outer side in a rotational radial direction.

A contact detecting device according to a fifth aspect includes: the contact detecting sensor according to any one of the first to fourth aspects; a first detection unit that detects a capacitance of the first electrode unit; a second detection unit that detects a capacitance of the second electrode unit; and a control unit that alternately operates the first detection unit and the second detection unit.

In a contact detecting device according to a sixth aspect, in the fifth aspect, each of the first electrode unit and the second electrode unit is disposed in a circumferential direction of the steering wheel on each of one side and the other side with a rotation center of the steering wheel interposed therebetween, the first detection unit and the second detection unit are disposed for the first electrode unit and the second electrode unit on each of the one side and the other side, and the control unit alternately operates the first detection unit and the second detection unit on the one side of the steering wheel and the first detection unit and the second detection unit on the other side of the steering wheel.

In a contact detecting device according to a seventh aspect, in the sixth aspect, the first detection unit detects a capacitance of the first electrode unit by setting a potential of the first electrode unit from a low potential to a predetermined high potential, the second detection unit detects a capacitance of the second electrode unit by setting a potential of the second electrode unit from a low potential to a predetermined high potential, and the control unit operates the first detection unit and the second detection unit on each of the one side and the other side such that the potentials of the first electrode unit and the second electrode unit on the one side and the potentials of the first electrode unit and the second electrode unit on the other side alternately reach a high level.

In a contact detecting device according to an eighth aspect, in any one of the fifth to seventh aspects, each of the first detection unit and the second detection unit detects a capacitance by setting the first electrode unit and the second electrode unit to the same potential.

### Advantageous Effects of Invention

In the contact detecting sensor according to the first aspect of the disclosure, the first electrode unit and the second electrode unit that detect contact of an operator with a circumferential surface of a rim portion are disposed in the rim portion of the steering wheel. The detection region of the first electrode unit and the detection region of the second electrode unit are located at positions different from each other in the circumferential direction of the rim portion, and the contact of the operator with the rim portion can be detected by at least one of the first electrode unit or the second electrode unit.

Here, the second electrode unit is disposed on an inner side of the first electrode unit in a radial direction of the rim portion. This can simplify the structure for separately disposing the first electrode unit and the second electrode unit in the rim portion.

In the contact detecting sensor according to the second aspect, the detection region of the first electrode unit and the detection region of the second electrode unit are continuous in the circumferential direction of the rim portion. This can suppress generation of a region where contact of the operator cannot be detected between the first electrode unit and the second electrode unit in the circumferential direction of the rim portion

In the contact detecting sensor according to the third aspect, one of the detection region of the first electrode unit and the detection region of the second electrode unit is located on a back side or a rotation center side of the steering wheel. This makes it possible to detect contact of a finger when the operator grips the steering wheel with one of the first electrode unit and the second electrode unit, and makes it possible to effectively detect a grip state of the steering wheel by the operator.

In the contact detecting sensor according to the fourth aspect, the other of the detection region of the first electrode unit and the detection region of the second electrode unit is located on a front side of the steering wheel or an outer side in a rotational radial direction. This makes it possible to detect contact of a palm when the operator grips the steering wheel with the other of the first electrode unit and the second electrode unit, and makes it possible to more effectively detect a grip state of the steering wheel by the operator.

In the contact detecting device according to the fifth aspect, the first detection unit detects a capacitance of the first electrode unit of the contact detecting sensor, and the second detection unit detects a capacitance of the second detection unit of the contact detecting sensor. The control unit alternately operates the first detection unit and the second detection unit, and detects the capacitance of the first electrode unit and the capacitance of the second electrode unit. This can suppress capacitive coupling caused by the first electrode unit and the second electrode unit, and can suppress a decrease in accuracy of detection of contact of the operator.

In the contact detecting device according to the sixth aspect, the first electrode unit and the second electrode unit are disposed in the circumferential direction of the steering wheel on each of one side and the other side with a rotation center of the steering wheel interposed therebetween. The first detection unit and the second detection unit are disposed for the first electrode unit and the second electrode unit on one side and the other side of the steering wheel, respectively.

Here, the control unit alternately operates the first detection unit and the second detection unit on one side of the steering wheel and the first detection unit and the second detection unit on the other side of the steering wheel. This makes it possible to effectively detect contact of the operator while suppressing a decrease in detection accuracy due to occurrence of capacitive coupling even when a plurality of electrode units is disposed on each of one side and the other side of the steering wheel.

In the contact detecting device according to the seventh aspect, each of the first detection units detects a capacitance of the first electrode unit by setting a potential of the first electrode unit from a low potential to a predetermined high potential, and each of the second detection units detects a capacitance of the second electrode unit by setting a potential of the second electrode unit from a low potential to a predetermined high potential.

The control unit operates the first detection unit and the second detection unit on each of one side and the other side such that the potentials of the first electrode unit and the second electrode unit on the one side and the potentials of the first electrode unit and the second electrode unit on the other side alternately reach a high level. This can suppress a decrease in detection accuracy due to capacitive coupling via the operator, and makes it possible to more effectively detect contact of the operator with each of the plurality of electrode units.

In the contact detecting device according to the eighth aspect, each of the first detection unit and the second detection unit detects a capacitance by setting the first electrode unit and the second electrode unit to the same potential. This makes it possible to use the second electrode unit as a shield electrode with respect to the first electrode unit, and makes it possible to use the first electrode unit as a shield electrode with respect to the second electrode unit. Therefore, noise can be suppressed, and detection accuracy can be effectively improved.

### BRIEF DESCRIPTION OF DRAWINGS

FIG. 1 is a schematic cross-sectional view of a main part of a steering wheel illustrating a sensor assembly according to the present embodiment.

FIG. 2 is a front view illustrating the steering wheel.

FIG. 3 is a schematic configuration diagram illustrating a contact detecting device according to the present embodiment.

FIG. 4A is a schematic cross-sectional view of a rim portion illustrating another example of the sensor assembly, taken along a radial direction of a steering wheel.

FIG. 4B is a schematic cross-sectional view of a rim portion illustrating another example of the sensor assembly, taken along a radial direction of a steering wheel.

FIG. 5A is a schematic cross-sectional view of a rim portion illustrating another example of the sensor assembly, taken along a radial direction of a steering wheel.

FIG. 5B is a schematic cross-sectional view of a rim portion illustrating another example of the sensor assembly, taken along a radial direction of a steering wheel.

### DESCRIPTION OF EMBODIMENTS

Hereinafter, an embodiment of the disclosure will be described in detail with reference to the drawings.

A contact detecting device 10 according to the present embodiment is disposed in a steering device 12. The steering device 12 includes an operation body and a steering wheel 14 as a steering body.

The contact detecting device 10 can be disposed in a vehicle on which an automatic driving system (not illustrated) is mounted. The automatic driving system switches between a manual driving mode in which a vehicle travels according to a driving operation of a driver and an automatic driving mode in which the vehicle travels without the driving operation of the driver, and enables the vehicle to travel in the automatic driving mode or the manual driving mode. The contact detecting device 10 detects a contact state of the driver with the steering wheel 14. In the automatic driving system, for example, using a detection result of the contact detecting device 10, it is determined, for example, whether or not the driver is in a state of being able to operate the steering wheel 14 at the time of shift to the manual driving mode.

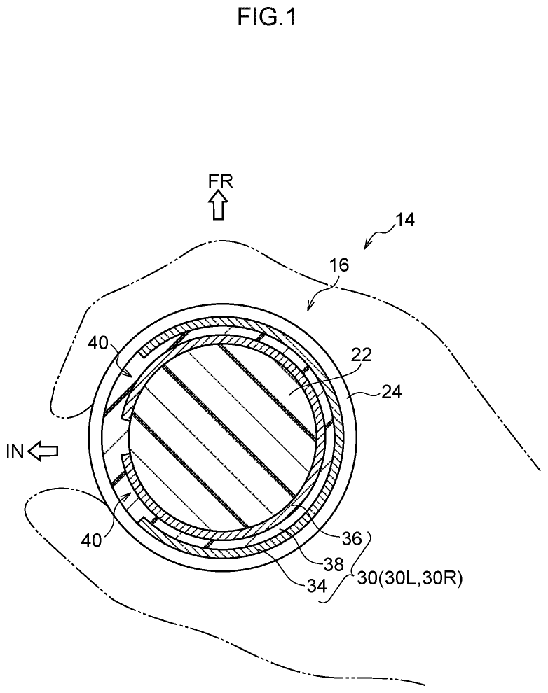

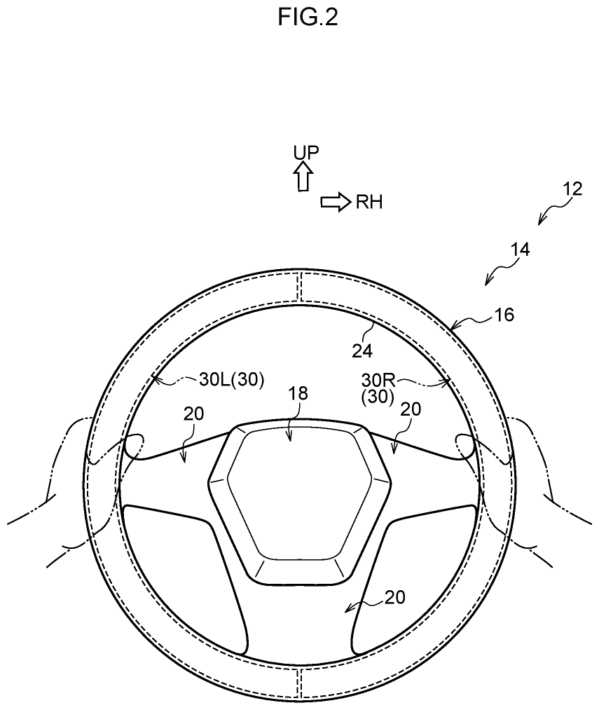

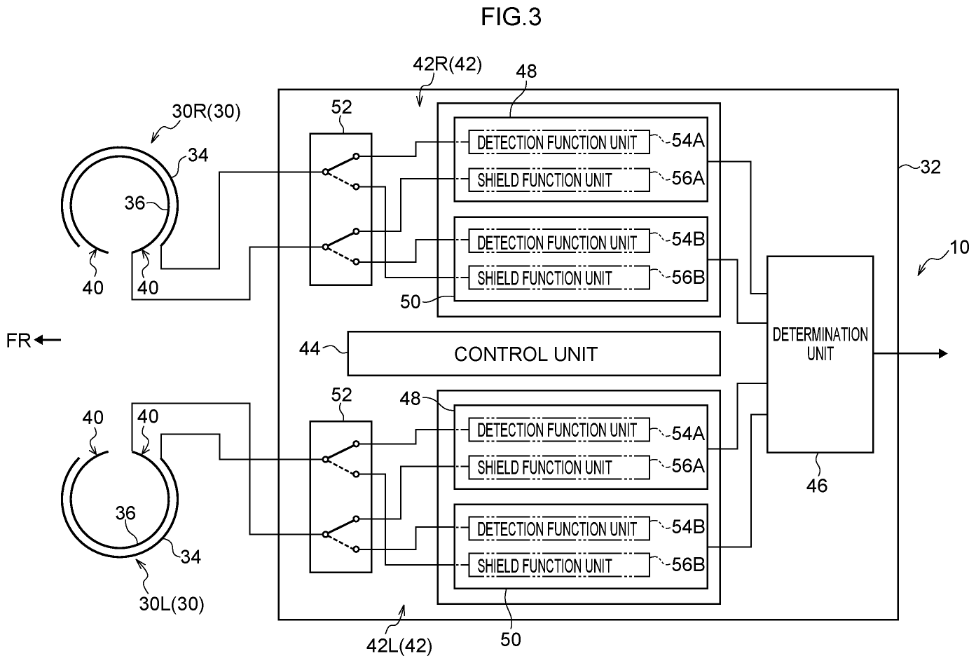

FIG. 1 illustrates a cross-sectional view of a main part of the steering wheel 14 according to the present embodiment, taken along a radial direction of the steering wheel 14, and FIG. 2 illustrates a front view of a main part of the steering device 12. FIG. 3 illustrates a schematic configuration diagram of a main part of the contact detecting device 10. In the drawings, a vehicle front side is indicated by an arrow FR, a vehicle width right side is indicated by an arrow RH, an upper side is indicated by an arrow UP, and an inner side in the radial direction of the steering wheel 14 is indicated by an arrow IN.

As illustrated in FIG. 2, the steering wheel 14 is formed in a substantially annular shape, and the steering wheel 14 is disposed on a vehicle front side of a seat (driver's seat) on which a driver (occupant) as an operator who drives the vehicle (steering target) is seated.

The steering wheel 14 includes an annular rim portion 16 as a grip portion, a boss portion 18 disposed at a center of the rim portion 16, and a stay portion 20 connecting the rim portion 16 and the boss portion 18 to each other. The steering wheel 14 includes a metal core bar constituting a framework, and the core bar includes an annular rim core bar portion of the rim portion 16, a boss core bar portion of the boss portion 18, and a stay core bar portion (all of which are not illustrated). In the steering wheel 14, the rim core bar portion and the boss core bar portion are connected to each other by the stay core bar portion, and the rim portion 16, the boss portion 18, and the stay portion 20 are integrated.

The steering device 12 includes a steering shaft (not illustrated), and the steering shaft is rotatably supported by a vehicle body with an axial direction being a substantially vehicle front-rear direction on a vehicle front side of the driver's seat. In the steering wheel 14, the boss core bar portion of the boss portion 18 is fixed to a vehicle rear side end of the steering shaft, and the steering wheel 14 is supported so as to be integrally rotatable with the steering shaft.

Therefore, by rotation of the steering wheel 14, the steering shaft is rotated to steer the vehicle. At this time, in the steering device 12, a rotation angle of the steering shaft is detected by a sensor (not illustrated), and an actuator (not illustrated) is operated according to the rotation angle of the steering shaft to steer a steering wheel. FIG. 2 illustrates the steering wheel 14 at a rotational position (straight advancing steering position) in a state where the vehicle travels straight.

As illustrated in FIG. 1, the rim portion 16 of the steering wheel 14 has a substantially circular (or substantially elliptical) cross section in the radial direction of the steering wheel 14, and a base body 22 is disposed in the rim portion 16. The base body 22 is made of a resin material such as urethane as an insulating material, and an outer circumference of the base body 22 in the radial direction of the steering wheel 14 has a substantially circular (or substantially elliptical) cross section. The rim core bar portion is housed in the base body 22 by insert molding (not illustrated), and the rim core bar portion is covered with the base body 22.

A decoration portion 24 as a contact portion (skin) is disposed on an outer circumferential portion of the base body 22. The decoration portion 24 has an insulating property, and the decoration portion 24 is made of leather, a resin, or the like (a part of the decoration portion 24 may be made of wood). In the rim portion 16, the entire circumference of the base body 22 in a radial cross section of the steering wheel 14 and the entire circumference (entire area) in a circumferential direction of the steering wheel 14 are covered with the decoration portion 24.

As illustrated in FIG. 3, the contact detecting device 10 includes a sensor assembly 30 as a contact detecting sensor and a controller 32. As illustrated in FIGS. 1 and 2, the sensor assembly 30 is disposed in the rim portion 16 of the steering wheel 14. The sensor assembly 30 includes a sensor assembly 30L on a vehicle left side of the steering wheel 14 and a sensor assembly 30R on a vehicle right side of the steering wheel 14.

As illustrated in FIG. 2, each of the sensor assemblies 30L and 30R is disposed over substantially a half circumference in a circumferential direction of the steering wheel 14, and the sensor assemblies 30L and 30R are in an electrical non-contact state with each other. Basic configurations of the sensor assemblies 30L and 30R are similar to each other, and hereinafter, in a case where the sensor assemblies 30L and 30R are not distinguished from each other, the sensor assemblies 30L and 30R will be described as the sensor assembly 30.

As illustrated in FIGS. 1 and 3, in the sensor assembly 30 (30L, 30R), a sensor electrode 34 as a first electrode unit (outer electrode) and a sensor electrode 36 as a second electrode unit (inner electrode) are disposed, and the sensor electrodes 34 and 36 are each formed in a band shape (may be formed in a sheet shape). In the sensor assembly 30, an insulating sheet 38 is disposed between the sensor electrodes 34 and 36, and in the sensor assembly 30, the sensor electrode 34, the insulating sheet 38, and the sensor electrode 36 are disposed in a layered shape to form a sheet shape as a whole.

As illustrated in FIG. 1, the sensor assembly 30 is disposed between the base body 22 and the decoration portion 24 in the rim portion 16, a width direction of the sensor assembly 30 is a circumferential direction (cross-sectional circumferential direction) of the rim portion 16, and a longitudinal direction of the sensor assembly 30 is a circumferential direction of the steering wheel 14. In the sensor assembly 30, the sensor electrode 36 is on the base body 22 side and covers an outer circumference of the base body 22 over substantially the entire circumference (substantially the entire circumference in the circumferential direction of the rim portion 16), and both ends of the sensor electrode 36 in a circumferential direction of the base body 22 are on an inner side in the radial direction of the steering wheel 14.

Therefore, in the sensor assembly 30, the sensor electrode 34 is disposed on an outer side in a radial direction of the rim portion 16 (cross-sectional radial direction), and the sensor electrode 36 is disposed on an inner side in the radial direction of the rim portion 16 and covered with the decoration portion 24. In the sensor assembly 30, the sensor electrode 34 is disposed at a center of the sensor electrode 36 in the circumferential direction of the rim portion 16 (a width direction of the sensor electrode 36), and projecting margin portions 40 serving as detection regions of the sensor electrode 36 are formed on both sides of the sensor electrode 34 in the circumferential direction of the rim portion 16.

As a result, a center of the sensor electrode 36 in the circumferential direction of the rim portion 16 is covered with the sensor electrode 34, and is exposed from the sensor electrode 34 (not covered) at the projecting margin portion 40. In the sensor assembly 30, the projecting margin portions 40 of the sensor electrode 36 are disposed on a vehicle front side (opposite side to the driver, back side) and a vehicle rear side (the driver side, front side) of the steering wheel 14 on a rotation center side (a radially inner side) of the steering wheel 14.

In the sensor assembly 30, when the driver grips the steering wheel 14 (rim portion 16) for driving operation, the sensor electrode 34 faces a palm of a driver's hand (palm), and the projecting margin portion 40 of the sensor electrode 36 exposed from the sensor electrode 34 faces a finger of the driver's hand. At this time, a thumb of the driver's hand faces one (vehicle rear side) of the projecting margin portions 40 of the sensor electrode 36, and the other fingers except the thumb face the other (vehicle front side) of the projecting margin portions 40 of the sensor electrode 36.

As a result, in the sensor assembly 30, when the driver grips the steering wheel 14, the driver's palm approaches (comes into contact with) the sensor electrode 34. In the sensor assembly 30, not only when the driver grips the steering wheel 14 but also when the driver touches the rim portion 16 of the steering wheel 14 so as to place his/her finger on the rim portion 16 while the driver does not grip the steering wheel 14, the driver's finger approaches (comes into contact with) the projecting margin portion 40 of the sensor electrode 36.

In the contact detecting device 10, the sensor assembly 30 is electrically connected to the controller 32, and the sensor electrodes 34 and 36 of each of the sensor assemblies 30L and 30R are connected to the controller 32.

In the sensor assembly 30 (30L, 30R), by contact of the driver's hand or the like with the sensor electrodes 34 and 36, an impedance such as a capacitance changes. In the controller 32, a capacitance is applied as an impedance, and a capacitance generated between each of the sensor electrodes 34 and 36 and the driver in the sensor assembly 30 or a change in the capacitance is detected by a self-capacitance method. The controller 32 determines whether or not the driver touches (the decoration portion 24 of the rim portion 16 of) the steering wheel 14 (a contact state) based on the detected capacitance (or change in the capacitance).

As illustrated in FIG. 3, the controller 32 includes a detection unit 42, a control unit 44 that controls an operation of the detection unit 42, and a determination unit 46 that determines a contact state of the driver with the steering wheel 14 based on a detection result of the detection unit 42.

The controller 32 is operated by power supplied from a power supply (battery of the vehicle) (not illustrated). The controller 32 includes a microcomputer (not illustrated) to which a CPU, a ROM, a RAM, a storage as a nonvolatile memory, and the like are connected by a bus. In the controller 32, the CPU executes a program stored in the ROM or the storage to implement functions of the control unit 44 and the determination unit 46, and the control unit 44 controls an operation of each detection unit 42.

The detection unit 42 includes a detection unit 42L corresponding to the sensor assembly 30L and a detection unit 42R corresponding to the sensor assembly 30R. Basic configurations of the detection units 42L and 42R are similar to each other, and hereinafter, in a case where the detection units 42L and 42R are not distinguished from each other, the detection units 42L and 42R will be described as the detection unit 42.

Each of the detection units 42 (42L, 42R) includes a contact detection circuit 48 as a first detection unit constituting a detection means, a contact detection circuit 50 as a second detection unit constituting a detection means, and a switching unit 52 as a switching means. The contact detection circuit 48 includes a detection function unit 54A and a shield function unit 56A, and the contact detection circuit 50 includes a detection function unit 54B and a shield function unit 56B.

The sensor electrodes 34 and 36 of the sensor assembly 30 are connected to a primary side of the switching unit 52. The detection function unit 54A of the contact detection circuit 48 and the shield function unit 56B of the contact detection circuit 50 are connected to a secondary side of the switching unit 52 corresponding to the sensor electrode 34, and the detection function unit 54B of the contact detection circuit 50 and the shield function unit 56A of the contact detection circuit 48 are connected to a secondary side of the switching unit 52 corresponding to the sensor electrode 36.

When detecting a capacitance of the sensor electrode 34, the control unit 44 connects the sensor electrode 34 to the detection function unit 54A, and controls the switching unit 52 so as to connect the sensor electrode 36 to the shield function unit 56A, thereby connecting the sensor electrodes 34 and 36 to the contact detection circuit 48.

By operation of the contact detection circuit 48, the detection function unit 54A and the shield function unit 56A supply a predetermined current (constant current) to the sensor electrode 34 and the sensor electrode 36, respectively, and the sensor electrode 34 is brought into a charged state corresponding to a capacitance while the sensor electrodes 34 and 36 are at the same potential (hereinafter referred to as an H level). The detection function unit 54A detects an electric signal (a current value or a voltage value) output from the sensor electrode 34 charged according to the capacitance. That is, the contact detection circuit 48 detects the capacitance of the sensor electrode 34 by changing a potential of the sensor electrode 34 from a low potential (L level) to a predetermined high potential (H level) and further changing the potential from the H level to the L level using a pulsed signal waveform having a predetermined cycle. In the contact detection circuit 48, when the capacitance of the sensor electrode 34 is detected, a potential of the sensor electrode 36 is changed together with the potential of the sensor electrode 34, and the sensor electrode 36 is used as a shield electrode.

When detecting a capacitance of the sensor electrode 36, the control unit 44 connects the sensor electrode 36 to the detection function unit 54B, and controls the switching unit 52 so as to connect the sensor electrode 34 to the shield function unit 56B, thereby connecting the sensor electrodes 34 and 36 to the contact detection circuit 50.

By operation of the contact detection circuit 50, the detection function unit 54B and the shield function unit 56B supply a predetermined current (constant current) to the sensor electrode 36 and the sensor electrode 34, respectively, and the sensor electrode 36 is brought into a charged state corresponding to a capacitance while the sensor electrodes 34 and 36 are at the same potential. The detection function unit 54B detects an electric signal (a current value or a voltage value) output from the sensor electrode 36 charged according to the capacitance. That is, similarly to the contact detection circuit 48, the contact detection circuit 50 detects the capacitance of the sensor electrode 36 by changing a potential of the sensor electrode 36 from an L level to an H level and further changing the potential from the H level to the L level using a pulsed signal waveform having a predetermined cycle. In the contact detection circuit 50, when the capacitance of the sensor electrode 36 is detected, a potential of the sensor electrode 34 is changed together with the potential of the sensor electrode 36, and the sensor electrode 34 is used as a shield electrode.

The control unit 44 alternately operates the contact detection circuits 48 and 50 to alternately detect a capacitance Ca of the sensor electrode 34 and a capacitance Cb of the sensor electrode 36 at a predetermined cycle.

Here, the control unit 44 detects the capacitances Ca and Cb in the sensor assembly 30L and detects the capacitances Ca and Cb in the sensor assembly 30R in parallel. At this time, the control unit 44 operates the detection unit 42L and the detection unit 42R in opposite phases, and operates the detection units 42L and 42R such that when potentials of the sensor electrodes 34 and 36 of one of the sensor assemblies 30L and 30R reach an H level, potentials of the sensor electrodes 34 and 36 of the other of the sensor assemblies 30L and 30R reach an L level.

Detection results of the detection units 42L and 42R are input to the determination unit 46. The determination unit 46 determines a contact state of the driver with respect to steering wheel 14 (sensor assembly 30L, 30R) based on the input detection result, and outputs a determination result. The detection result input to the determination unit 46 is a value (for example, a current value or a voltage value) corresponding to the capacitances Ca and Cb of the sensor electrodes 34 and 36 in each of the detection units 42L and 42R, and will be described below as the capacitances Ca and Cb.

When the driver operably grips the steering wheel 14, the driver's palm comes into contact with the sensor electrode 34 of the sensor assembly 30, and the driver's finger comes into contact with the sensor electrode 36. At this time, in the sensor electrode 36, a region corresponding to the driver's palm is covered with the sensor electrode 34, and thus, in the sensor electrode 36, the driver's finger mainly comes into contact with the projecting margin portion 40. As a result, the capacitances Ca and Cb corresponding to a contact state of the driver's hand are generated in the sensor electrodes 34 and 36, respectively.

In the determination unit 46, a threshold value Cadet by which it can be determined that the driver's hand (palm) is in contact with the sensor electrode 34 from the capacitance Ca of the sensor electrode 34 is set. In the determination unit 46, a threshold value Cbdet by which it can be determined that the driver's finger is in contact with the sensor electrode 36 (mainly the projecting margin portion 40) from the capacitance Cb of the sensor electrode 36 is set.

The determination unit 46 compares the capacitance Ca with the threshold value Cadet and compares the capacitance Cb with the threshold value Cbdet for each of the sensor assemblies 30L and 30R to determine a contact state of the driver for each of a vehicle left side of the steering wheel 14 corresponding to the sensor assembly 30L and a vehicle right side of the steering wheel 14 corresponding to the sensor assembly 30R. For example, when the capacitance Ca is equal to or larger than the threshold value Cadet (Ca≥Cadet), and the capacitance Cb is equal to or larger than the threshold value Cbdet (Cb≥Cbdet), the determination unit 46 determines that the driver is in a state of being able to perform a driving operation while gripping the steering wheel 14 with both hands.

In the contact detecting device 10, a determination result of the determination unit 46 is output to an automatic driving system disposed in the vehicle in response to a request from the automatic driving system. The contact detecting device 10 may determine (detect) whether or not the driver grips the steering wheel 14 in a state of being able to perform a driving operation in response to a request from an external device such as an automatic driving system, and output a detection result to the request source.

Hereinafter, an operation of the present embodiment will be described.

In the contact detecting device 10. the sensor assembly 30 (30L, 30R) is disposed in the steering wheel 14 of the steering device 12. In the sensor assembly 30, the sensor electrode 34 is disposed on the decoration portion 24 side of the rim portion 16, and the sensor electrode 36 is disposed on an inner side of the sensor electrode 34 in the radial direction of the rim portion 16. In the sensor assembly 30, the sensor electrode 34 is disposed on an outer side of the rim portion 16 (base body 22) in the radial direction of the steering wheel 14, and the projecting margin portion 40 of the sensor electrode 36 is disposed on an inner side in the radial direction of the steering wheel 14.

Therefore, the sensor electrode 34 is disposed at a center of the sensor electrode 36 in a width direction and covered. In the sensor electrode 36, the projecting margin portions 40 on an inner side in the radial direction of the steering wheel 14 and on a vehicle front side and a vehicle rear side are exposed from the sensor electrode 34. As a result, in the sensor assembly 30, when the driver grips (operably grips) the steering wheel 14, the driver's palm comes into contact with the sensor electrode 34, and the driver's finger comes into contact with the projecting margin portion 40 of the sensor electrode 36. At this time, in a region where the sensor electrode 34 covers the sensor electrode 36, the driver does not come into contact with the sensor electrode 36 (a capacitance is not generated between the sensor electrode 36 and the driver). Therefore, in the sensor assembly 30, the sensor electrode 34 can detect contact with an outer side of the rim portion 16 (contact with an outer side in the radial direction of the steering wheel 14), the sensor electrode 36 (projecting margin portion 40) can detect contact with an inner side of the rim portion 16 (contact with an inner side in the radial direction of the steering wheel 14), and the sensor electrodes 34 and 36 can detect grip of the rim portion 16.

The contact detecting device 10 operates when power supply to the controller 32 is started, for example, by turning on an ignition switch (not illustrated) of the vehicle, and stops the operation when travel of the vehicle ends, and the power supply to the controller 32 is stopped. The controller 32 executes a contact detection process using the sensor assembly 30 (30L, 30R) at a preset timing such as a predetermined time interval during operation.

In the controller 32 (control unit 44), in the contact detection process, the sensor electrode 34 is connected to the detection function unit 54A on the contact detection circuit 48 side by the switching unit 52 of each of the detection units 42L and 42R, and the sensor electrode 36 is connected to the shield function unit 56A on the contact detection circuit 48 side. As a result, it is possible to detect the capacitance Ca of the sensor electrode 34 of each of the sensor assemblies 30L and 30R.

The control unit 44 supplies power to the sensor electrode 34 and the sensor electrode 36 in one of the detection units 42L and 42R (charge of the sensor electrode 34, H level), and does not supply power to the sensor electrode 34 and the sensor electrode 36 in the other of the detection units 42L and 42R (L level).

Next, in the detection unit 42 (one of the detection units 42L and 42R) that supplies power to the sensor electrode 34, the control unit 44 stops power supply and measures (detects) the capacitance Ca of the sensor electrode 34 (L level). At substantially the same time, in the detection unit 42 (the other of the detection units 42L and 42R) that does not supply power to the sensor electrode 34, the control unit 44 supplies power to the sensor electrode 34 and the sensor electrode 34 (charges the sensor electrode 36) (H level).

Next, in the detection unit 42 (the other of the detection units 42L and 42R) that supplies power to the sensor electrode 34, the control unit 44 stops power supply and measures (detects) the capacitance Ca of the sensor electrode 34 (L level). At substantially the same time, in the detection unit 42 (one of the detection units 42L and 42R) that does not supply power to the sensor electrode 34, the control unit 44 supplies power to the sensor electrode 34 and the sensor electrode 34 (charges the sensor electrode 36) (H level).

As a result, the detection unit 42L can detect the capacitance Ca of the sensor electrode 34 in the sensor assembly 30L, and the detection unit 42R can detect the capacitance Ca of the sensor electrode 34 in the sensor assembly 30R.

Next, in the control unit 44, the switching unit 52 of each of the detection units 42L and 42R connects the sensor electrode 36 to the detection function unit 54B on the contact detection circuit 50 side, connects the sensor electrode 34 to the shield function unit 56B on the contact detection circuit 50 side, and detects the capacitance Cb of the sensor electrode 36 of each of the sensor assemblies 30L and 30R.

Thereafter, the control unit 44 supplies power to the sensor electrode 34 and the sensor electrode 36 in one of the detection units 42L and 42R (charge of the sensor electrode 36, H level), and does not supply power to the sensor electrode 34 and the sensor electrode 36 in the other of the detection units 42L and 42R (L level).

Next, in the detection unit 42 (one of the detection units 42L and 42R) that supplies power to the sensor electrode 36, the control unit 44 stops power supply and measures (detects) the capacitance Cb of the sensor electrode 36 (L level). At substantially the same time, in the detection unit 42 (the other of the detection units 42L and 42R) that does not supply power to the sensor electrode 36, the control unit 44 supplies power to the sensor electrode 34 and the sensor electrode 36 (H level).

Next, in the detection unit 42 (the other of the detection units 42L and 42R) that supplies power to the sensor electrode 36, the control unit 44 stops power supply and measures (detects) the capacitance Cb of the sensor electrode 36 (L level). At substantially the same time, in the detection unit 42 (one of the detection units 42L and 42R) that does not supply power to the sensor electrode 36, the control unit 44 supplies power to the sensor electrode 34 and the sensor electrode 36 (H level).

As a result, the detection unit 42L can detect the capacitance Ca of the sensor electrode 34 and the capacitance Cb of the sensor electrode 36 in the sensor assembly 30L. and the detection unit 42R can detect the capacitance Ca of the sensor electrode 34 and the capacitance Cb of the sensor electrode 36 in the sensor assembly 30R. The power supply and the stop of the power supply to the sensor electrodes 34 and 36 in each of the sensor assemblies 30L and 30R may be repeated a plurality of times.

The determination unit 46 performs contact determination on each of the sensor assemblies 30L and 30R using the capacitances Ca and Cb detected by each of the detection units 42L and 42R. In the contact determination, it is determined whether or not the driver's hand or the like is in contact with the sensor electrode 34 by comparing the capacitance Ca with the threshold value Cadet, and it is determined whether or not the driver's hand or the like is in contact with the sensor electrode 36 (projecting margin portion 40) by comparing the capacitance Cb with the threshold value Cbdet.

Here, when the driver's hand or the like is not in contact with the steering wheel 14. in the sensor assemblies 30L and 30R, the capacitance Ca of the sensor electrode 34 does not reach the threshold value Cadet (Ca<Cadet), and the capacitance Cb of the sensor electrode 36 does not reach the threshold value Cbdet (Cb<Cbdet). As a result, the determination unit 46 determines that the driver does not touch the steering wheel 14.

When the driver grips the steering wheel 14 with both hands, in each of the sensor assemblies 30L and 30R, the capacitance Ca of the sensor electrode 34 is equal to or larger than the threshold value Cadet (Ca≥Cadet), and the capacitance Cb of the sensor electrode 36 is equal to or larger than the threshold value Cbdet (Cb≥Cbdet). As a result, the determination unit 46 determines that the driver grips the steering wheel 14 with both hands.

When the driver grips the steering wheel 14 with one hand, in one of the sensor assemblies 30L and 30R, the capacitances Ca and Cb are equal to or larger than the threshold values Cadet and Cbdet, respectively, (Ca≥Cadet and Cb≥Cbdet), and in the other of the sensor assemblies 30L and 30R, the capacitances Ca and Cb are smaller than the threshold values Cadet and Cbdet, respectively (Ca<Cadet and Cb<Cbdet). As a result, the determination unit 46 can determine that steering wheel 14 is gripped with one hand, and can determine which of the left and right sides of the vehicle of the steering wheel 14 is gripped (which of the left and right sides is not gripped).

There is a case where only the driver's palm touches the steering wheel 14, or a part of the driver's body touches the steering wheel 14. In this case, for example, in the sensor assembly 30 (at least one of the sensor assembly 30L or 30R) of a corresponding portion, the capacitance Ca of the sensor electrode 34 is equal to or larger than the threshold value Cadet (Ca≥Cadet). At the same time, in the sensor assembly 30 (30L, 30R), the capacitance Cb of the sensor electrode 36 is smaller than the threshold value Cbdet (Cb≥Cbdet). As a result, the determination unit 46 can determine that the driver's palm or the like is in contact with a radially outer side of the steering wheel 14.

When the driver touches the steering wheel 14, there is a state in which a finger is placed on the steering wheel 14 (for example, a state in which a hand is moved to a vehicle front side of the steering wheel 14, and a finger touches an inner side in the radial direction of the steering wheel 14, finger hooking).

In this case, in the sensor assembly 30 (at least one of the sensor assembly 30L or 30R) of a corresponding portion, the capacitance Cb of the sensor electrode 36 is equal to or larger than the threshold value Cbdet (Cb≥Cbdet). At the same time, in the sensor assembly 30 (at least one of the sensor assembly 30L or 30R), the capacitance Ca of the sensor electrode 34 is smaller than the threshold value Cadet (Ca<Cadet). As a result, the determination unit 46 can determine that the driver's finger or the like is in contact with an inner side (radially inner side) of the steering wheel 14.

Therefore, the contact detecting device 10 can determine whether the steering wheel 14 is gripped with both hands of the driver, the steering wheel 14 is gripped with one hand, the driver touches a radially outer side of the steering wheel 14, or the driver touches a radially inner side of the steering wheel 14 (finger hooking), and the contact detecting device 10 can effectively detect a contact state of the driver with the steering wheel 14. When a driving mode is switched from an automatic driving mode to a manual driving mode, the automatic driving system can confirm whether or not the driver operably grips the steering wheel 14 from a determination result of the contact detecting device 10.

As described above, in the sensor assembly 30, the sensor electrode 36 is disposed in the base body 22 of the rim portion 16, and the sensor electrode 34 is disposed on an outer side of the sensor electrode 36 in the radial direction of the rim portion 16. In the sensor electrode 36 of the sensor assembly 30, the projecting margin portion 40 exposed from the sensor electrode 34 is a detection region. Therefore, in the sensor assembly 30, the detection region of the sensor electrode 34 and the detection region of the sensor electrode 36 are located at positions different from each other in the circumferential direction of the rim portion 16.

As a result, in the sensor assembly 30, contact of the driver with the rim portion 16 can be detected by at least one of the sensor electrode 34 or the sensor electrode 36. In the sensor assembly 30, since the sensor electrode 36 is disposed on an inner side of the sensor electrode 34 in the radial direction of the rim portion 16, it is possible to simplify a structure for separately disposing the sensor electrodes 34 and 36 having different detection regions in the circumferential direction of the rim portion 16. Moreover, in the sensor assembly 30, since the sensor electrode 34 and the sensor electrode 36 are layered in a sheet shape with the insulating sheet 38 interposed therebetween, the sensor electrode 34 and the sensor electrode 36 can be easily assembled to the rim portion 16.

In the sensor assembly 30, the detection region of the sensor electrode 34 and the detection region of the sensor electrode 36 are continuous in the circumferential direction of the rim portion 16. As a result, in the sensor assembly 30, it is possible to effectively suppress generation of a region where contact of the driver cannot be detected in the circumferential direction of the rim portion 16, and to accurately detect contact of the driver.

In the sensor assembly 30, since the sensor electrode 34 is superimposed on a part of the sensor electrode 36, continuity between the detection region of the sensor electrode 34 and the detection region of the sensor electrode 36 can be easily ensured, and the detection region of the sensor electrode 34 and the detection region of the sensor electrode 36 can be easily continuous in the circumferential direction of the rim portion 16.

In the sensor assembly 30, the sensor electrode 34 is superimposed on a center of the sensor electrode 36 in the circumferential direction of the rim portion 16. As a result, the detection region of the sensor electrode 34 and the detection region of the sensor electrode 36 can be effectively continuous in the circumferential direction of the rim portion 16.

In the sensor assembly 30, the detection region of the sensor electrode 34 is disposed on an outer side in the radial direction of the steering wheel 14, and the projecting margin portion 40 serving as the detection region of the sensor electrode 36 is disposed on an inner side in the radial direction of the steering wheel 14. As a result, contact of the driver's palm can be detected by the sensor electrode 34, and contact of the driver's finger can be detected by the projecting margin portion 40 of the sensor electrode 36. Therefore, it is possible to effectively detect whether or not the driver grips the steering wheel 14 so as to be able to perform a driving operation.

In the contact detecting device 10, the contact detection circuit 48 that detects the capacitance Ca of the sensor electrode 34 and the contact detection circuit 50 that detects the capacitance Cb of the sensor electrode 36 are alternately operated. Therefore, occurrence of capacitive coupling caused by a potential of the sensor electrode 34 and a potential of the sensor electrode 36 can be suppressed, and the capacitances Ca and Cb can be accurately detected.

In the contact detecting device 10, the sensor assembly 30L is disposed on a vehicle left side portion of the steering wheel 14, the sensor assembly 30R is disposed on a vehicle right side portion of the steering wheel 14, and the sensor assemblies 30L and 30R extend in the circumferential direction of the steering wheel 14. In the contact detecting device 10, the detection units 42L and 42R for detection contact with the sensor assembly 30L are disposed, and the detection units 42L and 42R are alternately operated.

When potentials of the sensor electrodes 34 and 36 of the sensor assembly 30L and potentials of the sensor electrodes 34 and 36 of the sensor assembly 30R are both high (H level) in a state where the driver is in contact with each of the sensor assemblies 30L and 30R. for example, in a state where the driver grips the steering wheel 14 with both hands, capacitive coupling via the driver occurs. As a result, the capacitances Ca and Cb in each of the sensor assemblies 30L and 30R decrease, and detection accuracy decreases.

Here, in the detection units 42L and 42R, potentials of the sensor electrodes 34 and 36 of the sensor assembly 30L and potentials of the sensor electrodes 34 and 36 of the sensor assembly 30R are changed in opposite phases. That is, while the potentials of the sensor electrodes 34 and 36 of the sensor assembly 30L change from H→L→H . . . , the potentials of the sensor electrodes 34 and 36 of the sensor assembly 30R change from L→H→L . . . , and the potentials of the sensor electrodes 34 and 36 of the sensor assembly 30L and the potentials of the sensor electrodes 34 and 36 of the sensor assembly 30R do not reach an H level at the same timing.

Therefore, in the contact detecting device 10, when the capacitances Ca and Cb are detected, a potential difference between the sensor electrodes 34 and 36 of the sensor assembly 30L and the sensor electrodes 34 and 36 of the sensor assembly 30R can be increased. As a result, in the contact detecting device 10, capacitive coupling can be suppressed even when the driver touches the steering wheel 14 with both hands. Therefore, the capacitances Ca and Cb of the sensor assemblies 30L and 30R can be accurately detected. and contact of the driver with the steering wheel 14 can be detected with high accuracy.

In the contact detecting device 10, when the capacitances Ca and Cb are detected, the sensor electrodes 34 and 36 of the sensor assembly 30 are set to the same potential. As a result, in the detection of the capacitance Ca of the sensor electrode 34, the sensor electrode 36 can be used as a shield electrode, and generation of a parasitic capacitance between the sensor electrode 34 and the sensor electrode 36, and the rim core bar portion in the base body 22 can be suppressed. In the detection of the capacitance Cb of the sensor electrode 36, the sensor electrode 34 can be used as a shield electrode, and generation of a parasitic capacitance caused by the sensor electrode 34 in the sensor electrode 36 can be suppressed. Therefore, in the contact detecting device 10, it is possible to suppress a noise component from being included in the capacitances Ca and Cb of the sensor assembly 30, and to effectively improve detection accuracy of the capacitances Ca and Cb.

In the present embodiment described above, the determination unit 46 is disposed in the controller 32. However, the contact detecting device only needs to detect and output the capacitances of the first electrode and the second electrode, and the contact state of an operator with the steering wheel may be performed by an external device such as an automatic driving system.

In the present embodiment, each of the sensor assemblies 30L and 30R is disposed over substantially a half circumference in the circumferential direction of the steering wheel 14. However, each of a plurality of contact detecting sensors may be disposed within a predetermined angle range in the steering wheel. One contact detecting sensor may be disposed over substantially the entire circumference of the steering wheel.

In the present embodiment, the contact detection circuit 48 using the sensor electrode 36 as a shield electrode when the capacitance Ca of the sensor electrode 34 is detected, and the contact detection circuit 50 using the sensor electrode 34 as a shield electrode when the capacitance Cb of the sensor electrode 36 is detected are used. However, when the detection unit detects the capacitance of one of the outer electrode and the inner electrode, the other of the outer electrode and the inner electrode may be grounded (GND).

In the present embodiment described above, the outer side of the sensor electrode 36 in the radial direction of the steering wheel 14 is covered with the sensor electrode 34, and the projecting margin portion 40 of the sensor electrode 36 not covered with the sensor electrode 34 is disposed on an inner side in the radial direction of the steering wheel 14. However, the contact detecting sensor is not limited to the configuration in which a part of the second electrode unit overlaps with the first electrode unit in the circumferential direction of the rim portion, and the contact detecting sensor may have a configuration in which the first electrode unit and the second electrode unit do not overlap with each other in the circumferential direction of the rim portion.

In the contact detecting sensor, one of the detection region of the first electrode unit and the detection region of the second electrode unit only needs to be located on a back side of the steering wheel (vehicle front side) or a rotation center side of the steering wheel. In the contact detecting sensor, one of the detection region of the first electrode unit and the detection region of the second electrode unit may correspond to a contact position of a finger of an operator who grips the steering wheel, and the other of the detection region of the first electrode unit and the detection region of the second electrode unit may correspond to a contact position of a palm of the operator who grips the steering wheel.

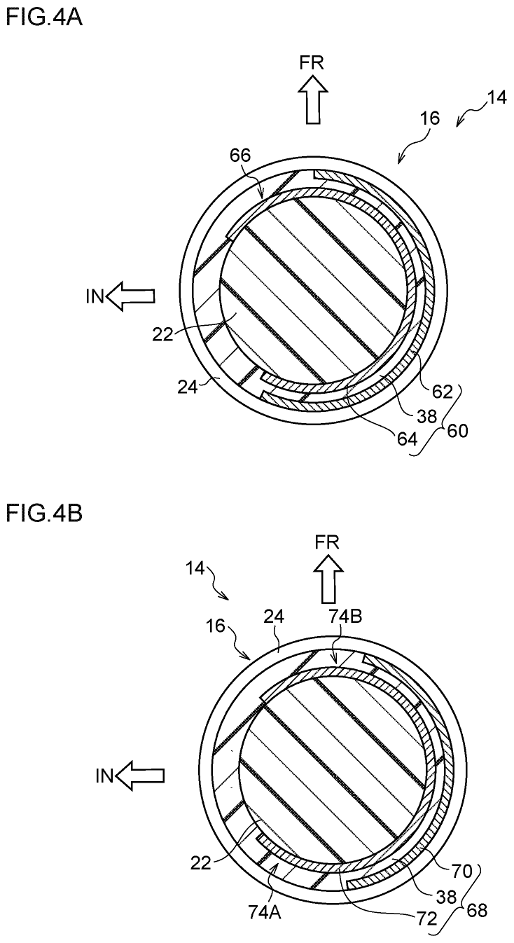

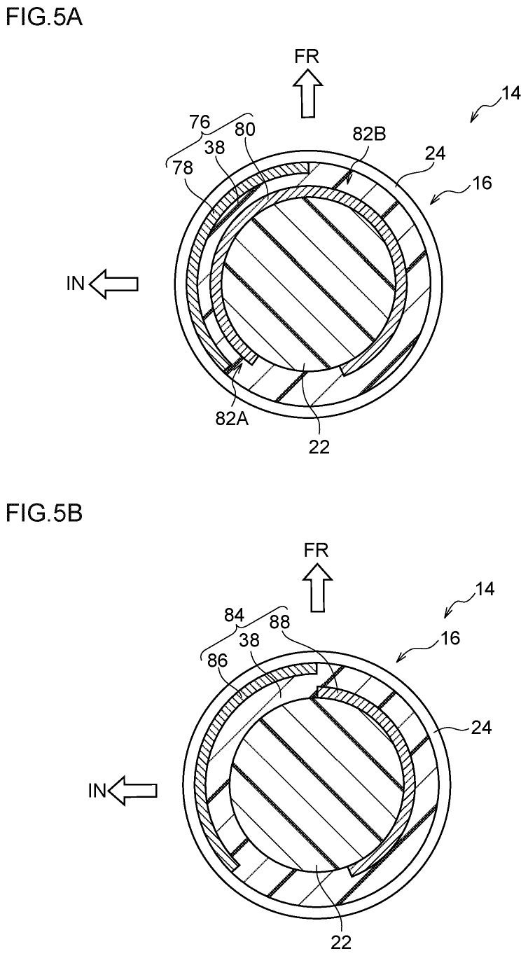

Here, FIGS. 4A, 4B, 5A, and 5B are schematic cross-sectional views of contact detecting sensors different from the sensor assembly 30 (30L, 30R), taken along the radial direction of the steering wheel 14.

As illustrated in FIG. 4A, in a sensor assembly 60 as a contact detecting sensor, a sensor electrode 62 as a first electrode unit and a sensor electrode 64 as a second electrode unit are layered with the insulating sheet 38 interposed therebetween. In the sensor assembly 60, the sensor electrode 64 is disposed on the base body 22 side (an inner side in the radial direction of the rim portion 16), and the sensor electrode 62 is disposed on the decoration portion 24 side (an outer side in the radial direction of the rim portion 16)

The sensor electrode 62 of the sensor assembly 60 is disposed around the base body 22 from a vehicle rear side to a vehicle front side via an outer side in the radial direction of the steering wheel 14 in the circumferential direction (cross-sectional circumferential direction) of the rim portion 16. One end of the sensor electrode 62 in the circumferential direction of the rim portion 16 is located on the vehicle front side, and the other end of the sensor electrode 62 in the circumferential direction of the rim portion 16 is located closer to an inner side in the radial direction of the steering wheel 14 on the vehicle rear side.

The sensor electrode 64 of the sensor assembly 60 is disposed around the base body 22 from the vehicle rear side to an inner side in the radial direction of the steering wheel 14 via an outer side in the radial direction of the steering wheel 14 and the vehicle front side in the circumferential direction of the rim portion 16. One end of the sensor electrode 64 in the circumferential direction of the rim portion 16 is located on an inner side in the radial direction of the steering wheel 14, and the other end of the sensor electrode 64 in the circumferential direction of the rim portion 16 is located closer to an inner side in the radial direction of the steering wheel 14 on the vehicle rear side. As a result, in the sensor electrode 64, a projecting margin portion 66 as a detection region of the sensor electrode 64 is formed closer to the vehicle front side on an inner side in the radial direction of the steering wheel 14 from the vehicle front side.

In the sensor assembly 60 with such a configuration, when the driver grips the steering wheel 14, the driver's palm comes into contact with the sensor electrode 62, and the driver's finger comes into contact with the projecting margin portion 66 of the sensor electrode 64. As a result, the sensor assembly 60 can detect a contact state of the driver similarly to the sensor assembly 30.

As illustrated in FIG. 4B, in a sensor assembly 68 as a contact detecting sensor, a sensor electrode 70 as a first electrode unit and a sensor electrode 72 as a second electrode unit are layered with the insulating sheet 38 interposed therebetween. In the sensor assembly 68, the sensor electrode 70 is disposed on the decoration portion 24 side (an outer side in the radial direction of the rim portion 16), and the sensor electrode 72 is disposed on the base body 22 side (an inner side in the radial direction of the rim portion 16).

The sensor electrode 70 of the sensor assembly 68 is disposed on an outer side in the radial direction of the steering wheel 14 within a range of from a vehicle front side to a vehicle rear side in the circumferential direction (cross-sectional circumferential direction) of the rim portion 16. One end of the sensor electrode 70 in the circumferential direction of the rim portion 16 is located close to the outer side in the radial direction of the steering wheel 14 on the vehicle front side, and the other end of the sensor electrode 70 in the circumferential direction of the rim portion 16 is located close to the outer side in the radial direction of the steering wheel 14 on the vehicle rear side.

The sensor electrode 72 of the sensor assembly 68 is disposed around the base body 22 from a substantially inner side in the radial direction of the steering wheel 14 to the substantially inner side in the radial direction of the steering wheel 14 via the vehicle rear side, the outer side in the radial direction of the steering wheel 14, and the vehicle front side in the circumferential direction of the rim portion 16. One end of the sensor electrode 72 in the circumferential direction of the rim portion 16 is located close to the vehicle rear side on an inner side in the radial direction of the steering wheel 14, and the other end of the sensor electrode 72 in the circumferential direction of the rim portion 16 is located close to the vehicle front side on an inner side in the radial direction of the steering wheel 14. As a result, in the sensor assembly 68, a projecting margin portion 74A as a detection region of the sensor electrode 72 is formed closer to an inner side in the radial direction of the steering wheel 14 on the vehicle rear side, and a projecting margin portion 74B is formed closer to an inner side in the radial direction of the steering wheel 14 on the vehicle front side.

In the sensor assembly 68 with such a configuration, when the driver grips the steering wheel 14, the driver's palm comes into contact with the sensor electrode 70, and the finger of the driver's hand (finger side) comes into contact with the projecting margin portions 74A and 74B of the sensor electrode 72. As a result, the sensor assembly 68 can detect a contact state of the driver similarly to the sensor assembly 30.

As illustrated in FIG. 5A, in a sensor assembly 76 as a contact detecting sensor, a sensor electrode 78 as a first electrode unit and a sensor electrode 80 as a second electrode unit are layered with the insulating sheet 38 interposed therebetween. In the sensor assembly 76, the sensor electrode 78 is disposed on the decoration portion 24 side (an outer side in the radial direction of the rim portion 16), and the sensor electrode 80 is disposed on the base body 22 side (an inner side in the radial direction of the rim portion 16).

The sensor electrode 78 of the sensor assembly 76 is disposed around the base body 22 from a portion close to an inner side in the radial direction of the steering wheel 14 on the vehicle rear side to the vehicle front side via the inner side in the radial direction of the steering wheel 14 in the circumferential direction of the rim portion 16 (cross-sectional circumferential direction). One end of the sensor electrode 78 in the circumferential direction of the rim portion 16 is located close to the vehicle rear side on an inner side in the radial direction of the steering wheel 14, and the other end of the sensor electrode 78 in the circumferential direction of the rim portion 16 is located on the vehicle front side.

The sensor electrode 80 of the sensor assembly 76 is disposed from a portion close to an outer side in the radial direction of the steering wheel 14 on the vehicle rear side to a portion close to an inner side in the radial direction of the steering wheel 14 on the vehicle rear side via the outer side in the radial direction of the steering wheel 14, the vehicle front side, and an inner side in the radial direction of the steering wheel 14 in the circumferential direction of the rim portion 16. One end of the sensor electrode 80 in the circumferential direction of the rim portion 16 is located close to an inner side in the radial direction of the steering wheel 14 on the vehicle rear side, and the other end of the sensor electrode 80 in the circumferential direction of the rim portion 16 is located close to the outer side in the radial direction of the steering wheel 14 on the vehicle rear side. As a result, in the sensor assembly 76, a projecting margin portion 82A as a detection region of the sensor electrode 80 is formed closer to an inner side in the radial direction of the steering wheel 14 on the vehicle rear side, and a projecting margin portion 82B is formed within a region from the vehicle front side to an outer side in the radial direction of the steering wheel 14 on the vehicle rear side via the outer side in the radial direction of the steering wheel 14.

In the sensor assembly 76 with such a configuration, when the driver grips the steering wheel 14, the driver's palm comes into contact with the projecting margin portion 82B (and the margin portion 82A) of the sensor electrode 80, and the driver's finger comes into contact with the sensor electrode 78. As a result, the sensor assembly 76 can detect a contact state of the driver similarly to the sensor assembly 30.

As illustrated in FIG. 5B, in a sensor assembly 84 as a contact detecting sensor, a sensor electrode 86 as a first electrode unit and a sensor electrode 88 as a second electrode unit are layered with the insulating sheet 38 interposed therebetween. In the sensor assembly 84, the sensor electrode 86 is disposed on the decoration portion 24 side (an outer side in the radial direction of the rim portion 16), and the sensor electrode 88 is disposed on the base body 22 side (an inner side in the radial direction of the rim portion 16).

The sensor electrode 86 of the sensor assembly 84 is disposed on an inner side in the radial direction of the steering wheel 14 in the circumferential direction (cross-sectional circumferential direction) of the rim portion 16. One end of the sensor electrode 86 in the circumferential direction of the rim portion 16 is located on the vehicle front side, and the other end of the sensor electrode 86 in the circumferential direction of the rim portion 16 is located close to the vehicle rear side on an inner side in the radial direction of the steering wheel 14.

The sensor electrode 88 of the sensor assembly 84 is disposed on an outer side in the radial direction of the steering wheel 14 in the circumferential direction of the rim portion 16. One end of the sensor electrode 88 in the circumferential direction of the rim portion 16 is located on the vehicle front side, and the other end of the sensor electrode 88 in the circumferential direction of the rim portion 16 is located close to the outer side in the radial direction of the steering wheel 14 on the vehicle rear side. As a result, the sensor electrode 88 does not overlap with the sensor electrode 86 in the circumferential direction of the rim portion 16, and the sensor electrode 88 is exposed from the sensor electrode 86.

In the sensor assembly 84 with such a configuration, when the driver grips the steering wheel 14, the driver's palm comes into contact with the sensor electrode 88, and the finger of the driver's hand comes into contact with the sensor electrode 86. As a result, the sensor assembly 84 can detect a contact state of the driver similarly to the sensor assembly 30.

In the present embodiment and the modifications described above, the grip determination of the steering wheel 14 by the driver is performed by detecting contact of the driver's palm with one of the two sensor electrodes and detecting contact of the finger of the driver's hand with the other of the two sensor electrodes. However, in the contact detection for the grip determination, a predetermined finger (thumb) of the driver's hand may be detected with one of the first electrode unit and the second electrode unit, and contact of a finger other than the predetermined finger of the driver's hand (a finger other than the thumb) may be detected with the other of the first electrode unit and the second electrode unit. In this case, one of the first electrode unit and the second electrode unit may be disposed (set) on a front side (and a rotation center side) of the steering wheel, and the other of the first electrode unit and the second electrode unit may be disposed on a back side (and the rotation center side) of the steering wheel.

The first electrode unit and the second electrode unit only need to be disposed within a range of an idea of being disposed at different positions in the circumferential direction of the rim portion, and the first electrode unit and the second electrode unit only need to be disposed at positions set, if appropriate, according to the shape of the steering wheel and the shape of the rim portion.

The whole of the disclosure of Japanese Patent Application No. 2021-033843 filed on Mar. 3, 2021 is incorporated herein by reference.

All the documents, patent applications, and technical standards described here are incorporated herein by reference to almost the same extent as a case where incorporation of each document, each patent application, and each technical standard by reference is specifically and individually described.

1. A contact detecting sensor comprising:
a first electrode unit that is disposed in a rim portion of a steering wheel, the first electrode unit being configured to detect contact of an operator with a circumferential surface of the rim portion; and
a second electrode unit that is disposed on an inner side, in a radial direction, of the rim portion with respect to the first electrode unit, the second electrode unit having a detection region to be used for detecting contact of the operator with the circumferential surface of the rim portion, the detection region of the second electrode unit being located at a position different from a position of a detection region of the first electrode unit in a circumferential direction of the rim portion.

2. The contact detecting sensor according to claim 1, wherein the detection region of the first electrode unit and the detection region of the second electrode unit are continuous in the circumferential direction of the rim portion.

3. The contact detecting sensor according to claim 1, wherein one of the detection region of the first electrode unit or the detection region of the second electrode unit is located on a back side or a rotation center side of the steering wheel.

4. The contact detecting sensor according to claim 3, wherein the other of the detection region of the first electrode unit or the detection region of the second electrode unit is located on a front side of the steering wheel or an outer side of the steering wheel in a rotational radial direction.

5. A contact detecting device comprising:
the contact detecting sensor according to claim 1;
a first detection unit that detects a capacitance of the first electrode unit;
a second detection unit that detects a capacitance of the second electrode unit; and
a control unit that alternately operates the first detection unit and the second detection unit.

6. The contact detecting device according to claim 5, wherein:
each of the first electrode unit and the second electrode unit is disposed in a circumferential direction of the steering wheel on each of one side and the other side with a rotation center of the steering wheel interposed therebetween,
the first detection unit and the second detection unit are disposed for the first electrode unit and the second electrode unit on each of the one side and the other side, and
the control unit alternately operates the first detection unit and the second detection unit on the one side of the steering wheel and the first detection unit and the second detection unit on the other side of the steering wheel.

7. The contact detecting device according to claim 6, wherein:
the first detection unit detects a capacitance of the first electrode unit by setting a potential of the first electrode unit from a low potential to a predetermined high potential, the second detection unit detects a capacitance of the second electrode unit by setting a potential of the second electrode unit from a low potential to a predetermined high potential, and
the control unit operates the first detection unit and the second detection unit on each of the one side and the other side such that the potentials of the first electrode unit and the second electrode unit on the one side and the potentials of the first electrode unit and the second electrode unit on the other side alternately reach a high level.

8. The contact detecting device according to claim 1, wherein each of the first detection unit and the second detection unit detects a capacitance by setting the first electrode unit and the second electrode unit to the same potential.
